(19) United States
(12) Patent Application Publication
(10) Pub. No.: US 2010/0131182 A1
(43) Pub. Date: May 27, 2010

(54) SYSTEMS AND METHODS FOR MEASURING WEIGHT AND WEIGHT DISTRIBUTION OF A PAYLOAD

(76) Inventors: Michael Deegan, Arlington, VA (US); Paul Nephi Lowe, Riverside, CA (US)

Correspondence Address: JOHN S. BEULICK (24691);ARMSTRONG TEASDALE LLP, ONE METROPOLITAN SQUARE, SUITE 2600, ST. LOUIS, MO, 63102-2740, US

(21) Appl. No.: 12/275,349

(22) Filed: Nov. 21, 2008

(51) Int. Cl. G06F 17/00; G08B 21/00

(52) U.S. Cl. 701/124; 340/431

(57) ABSTRACT

Described herein is a method for measuring a weight and location of a payload in a carrying means coupled to a vehicle. The method including sensing the weight of the payload with at least one sensor, sensing the location of the payload with the at least one sensor, generating a location of the payload with respect to one or more axles rotatably supporting the carrying means, determining whether the weight of the payload is below a maximum weight threshold, determining whether the location of the payload is below a maximum distribution threshold with respect to the one or more axles, and presenting results to a user.

### BACKGROUND

The present disclosure relates generally to systems and methods for measuring weight and weight distribution of a payload. More particularly, the present disclosure relates to systems and methods for measuring weight and weight distribution of a payload on a vehicle and/or carrying means.

When a vehicle is used, it is necessary, for technical reasons, to comply with maximum weight restrictions with respect to the vehicle and the axle payload which bears on each individual axle of the vehicle. If the vehicle has a trailer hitch and is towing a trailer, there exists a maximum overall weight of the vehicle combination, composed of the already mentioned overall weight of the vehicle and the weight of the trailer with which to comply. Although the maximum values for the aforesaid weights are recorded in the vehicle's user manual, in practice, only a small number of users are aware of the precise significance of these parameters, and a correspondingly small number of users pay attention to them when loading their vehicle and/or trailer. It is therefore frequently the case that the permitted maximum weight values are exceeded and a vehicle and/or trailer is overloaded. As a result, the dynamics of the vehicle and/or trailer that is overloaded is degraded.

Further, another key to safety is proper distribution of the payload on the vehicle and/or trailer. Many people underestimate the seriousness involved in not loading a vehicle and/or trailer properly. That is, placing a majority of the payload on a particular side of the vehicle and/or trailer, which may cause the vehicle and/or trailer to overturn during use. Thus, a vehicle that may be in compliance with weight restrictions, may not be properly distributed with respect to the payload that it is carrying and is therefore at a serious risk of overturning due to the improper distribution of weight.

As indicated above, current systems have considerable gaps owing to the fact that a user who transports a certain payload in a vehicle and/or trailer may possibly exceed weight restrictions and/or weight distribution limits, as current systems only take into account conditions of the vehicle and/or trailer at a time of loading, if at all. However, the weight and distribution of a payload changes during a course of use. That is, more items may be added to the payload during a journey and the payload may shift during the journey, thus making a payload that was once distributed properly, now unsafe and improperly distributed.

Accordingly, a need is present for a system and method for measuring a weight and a weight distribution of a payload on a vehicle and/or trailer.

### SUMMARY

Described herein are systems and methods for measuring a weight and weight distribution of a payload on a vehicle coupled to a carrying means.

In embodiments, described is a method for measuring a weight and location of a payload in a carrying means coupled to a vehicle. The method including sensing the weight of the payload with at least one sensor, sensing the location of the payload with the at least one sensor, generating a location of the payload with respect to one or more axles rotatably supporting the carrying means, determining whether the weight of the payload is below a maximum weight threshold or determining whether the location of the payload is below a maximum distribution threshold with respect to the one or more axles, and presenting results to a user.

In further embodiments, described is a system for measuring a weight and location of a payload in a carrying means coupled to a vehicle. The system including a memory area for storing weight and location thresholds including a maximum weight threshold and a maximum distribution threshold of the carrying means, and a processor. The processor is programmed to receive the weight of the payload determined by at least one sensor, receive the location of the payload determined by the at least one sensor, generate a location of the payload with respect to one or more axles rotatably supporting the carrying means coupled to the vehicle, determine whether the weight of the payload is below the maximum weight threshold stored in the memory area, determine whether the location of the payload is below the maximum distribution threshold stored in the memory area with respect to the one or more axles, and present results to a user.

In still further embodiments, described is a cargo transportation device including, a cargo holding area, a plurality of weight sensors dispersed about the cargo holding area, and a load controller communicatively coupled to the weight sensors and programmed to ensure proper distribution with respect to a payload in the cargo holding area.

### BRIEF DESCRIPTION OF THE DRAWINGS

FIG. 1 is a block diagram illustrating a vehicle having a weight and weight distribution monitoring system.

FIG. 2 is a flow diagram of an exemplary method for measuring weight and weight distribution of a payload on a vehicle.

FIG. 3 is a block diagram illustrating a trailer having a plurality of sensors locationed on the floor of the trailer.

### DETAILED DESCRIPTION

The subject matter of the present disclosure is described with specificity herein to meet statutory requirements. However, the description itself is not intended to limit the scope of this patent. Rather, the claimed subject matter might also be embodied in other ways, to include different steps or combinations of steps similar to the ones described in this document, in conjunction with other present or future technologies. Moreover, although the terms “step,” “block,” and/or “operation” may be used herein to connote different elements of methods employed, the terms should not be interpreted as implying any particular order among or between various steps herein disclosed unless and except when the order of individual steps is explicitly described.

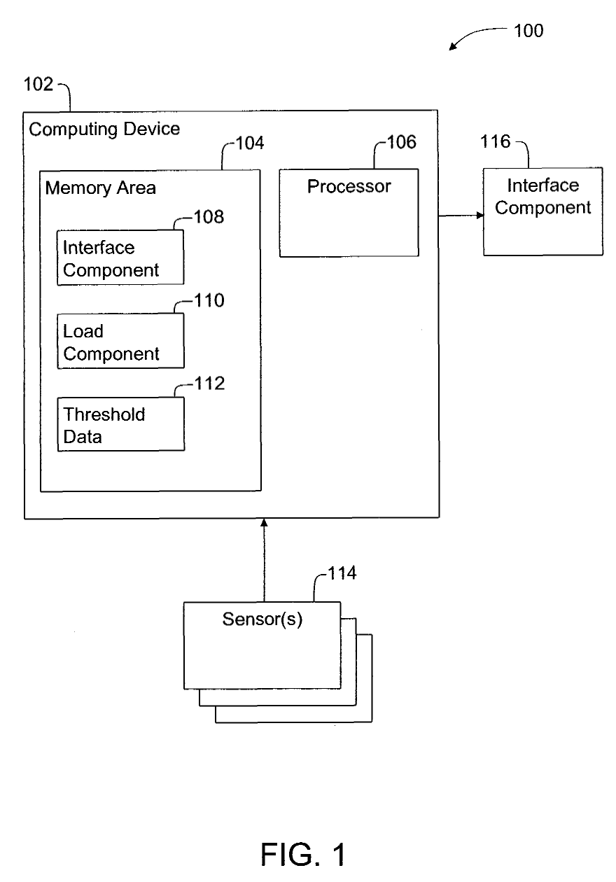

Referring initially to FIG. 1, an exemplary operating environment is illustrated as a block diagram of a system 100 for measuring a weight and weight distribution of a payload in a cargo transportation device (e.g., a vehicle) coupled to a carrying means (e.g., cargo holding area). In embodiments, the carrying means is one of the following: a trailer, a railroad car, a boat, an airplane; a bed of a truck, and the like. The weight and weight distribution of the payload of the vehicle coupled to the carrying means is measured via at least one sensor 114 coupled to a computing device 102. In embodiments, the at least one sensor 114 and the computing device 102 may be connected via a wire, or wireless network, such as a situation control and data acquisition link.

In embodiments, the computing device 102 includes a memory area 104 and at least one processor 106. Although the processor 106 is shown separate from the memory area 104 in FIG. 1, embodiments of the disclosure contemplate that the memory area 104 may be onboard the processor 106, such as in some embedded systems. The diagram of FIG. 1 is merely illustrative of an exemplary computing device that can be used in connection with one or more embodiments of the disclosure, and is not intended to be limiting in any way. Further, peripherals or components of the computing device 102 known in the art are not shown, but are operable with aspects of the disclosure.

Memory area 104, or other computer-readable media, stores computer-executable components for measuring/monitoring a weight and location of a payload in a carrying means coupled to a vehicle. Exemplary components include, but are not limited to an interface component 108 and a load component 110. The memory area 104 stores threshold data 112 including a maximum weight threshold and a maximum distribution threshold of the vehicle and the carrying means. In further embodiments, weight threshold data may include, in particular, a payload weight, a payload weight and an overall weight of the vehicle, a payload weight and a weight of the vehicle and the carrying means (e.g., a trailer combination (vehicle and trailer)), and a payload and a weight of the carrying means. In embodiments, a maximum weight threshold is about 90% of a maximum weight. That is, the payload may weight up to 90% of the maximum weight requirement. In further embodiments, the pay load may weight up to about 80% of the maximum weight requirement. In still further embodiments, the payload may weigh up to about 95% of the maximum weight requirement. In embodiments, a minimum distribution threshold of weight over a particular portion of the vehicle or carrying means, such as over an axle or a center portion of a vehicle, is about 95%. That is, 95% of the payload needs to be over, for example, the axle. In other embodiments, the minimum distribution threshold may be about 60% to about 90%.

In embodiments, the vehicle and carrying means information (e.g., vehicle and carrying means specifications, such as maximum weight threshold and number of axles, weight of vehicle, etc.) may be programmed into the computing device 102 by a manufacturer of the vehicle and/or carrying means in accordance with specifications for maximum payload thresholds and the like. However, in embodiments, the programming of the vehicle and carrying means information into the computing device 102 may be carried out by a competent user via user the interface component 108.

Further, although the interface component 108 is shown within the memory area 104, embodiments of the disclosure contemplate that the interface component 108 may be separate from the computing device 102, such as interface component 116 in FIG. 1. In embodiments, the computing device 102 may be in a cabin of the vehicle and therefore include the interface component 108 in the computing device 102. However, if the computing device is located outside of the cabin of the vehicle, in embodiments, the interface component 116 may be place in the cabin of the vehicle and communicate with the computing device via wire or wirelessly.

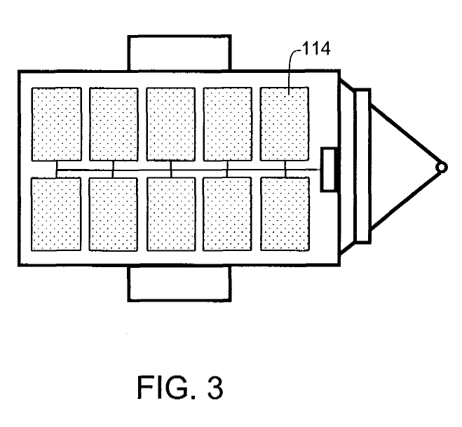

In embodiments, the at least one sensor 114 senses a weight of a payload and senses a distribution of the payload. In further embodiments, the at least one sensor 114 is located on a floor of the carrying means, for example, the floor of a trailer or a truck bed, as shown in FIG. 3. The at least one sensor 114 may also be embedded within a floor or under a floor of, for example, a truck bed or trailer. In still further embodiments, the at least one sensor 114 may be located to determine a weight acting on each individual wheel if the vehicle and/or carrying means. Both an overall weight and a respective axle load can then be determined from this information. In embodiments, the at least one sensor 114 may be a pressure sensor in a pneumatic or hydraulic suspension system and/or a distance sensor in conventional spring/damper suspension systems. Depending on a type of sensor used for the at least one sensor 114, in embodiments, the at least one sensor 114 may be able to determine a weight of a payload using only one sensor, but unable to determine a distribution of a payload using only the one sensor. Thus, in this embodiment, multiple sensors, for example four sensors, may be used to measure a weight distribution in two-dimensions, for example, left and right distributions as well as front and back distributions of a vehicle's payload may be calculated. For example, a vehicles payload may be left-right of a vehicle's center-line, laterally along the vehicle's center-line, and/or in-front-of or in-back-of a specified point on the vehicle, such as an axle.

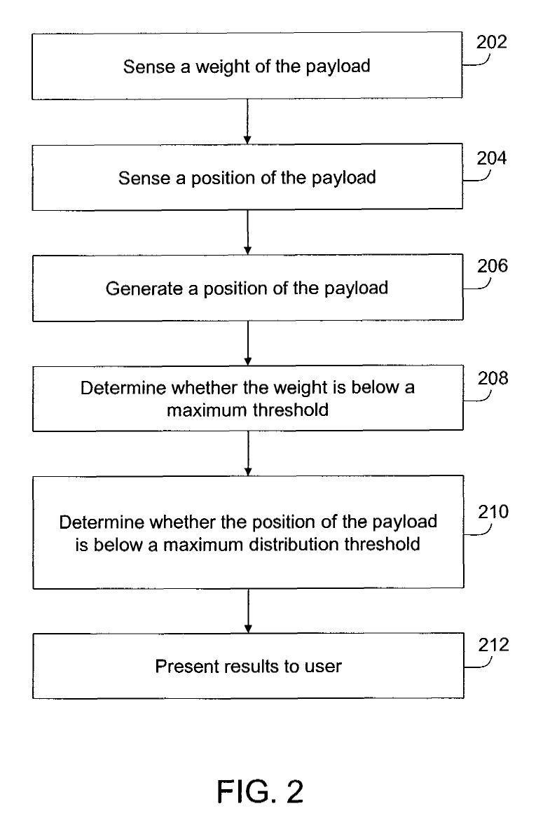

Referring next to FIG. 2, a flow diagram of an exemplary method for measuring weight and weight distribution of a payload on a vehicle is illustrated. The method begins when a weight of a payload is sensed 202 and a distribution of a payload is sensed 204 with at least one sensor 114. In embodiments, a distribution of the payload is generated 206 with respect to one or more axles rotatably supporting the carrying means. Utilizing the information provided by the at least one sensor 114, the interface component 108 (or interface component 116) generates a location of the payload with respect to one or more axles rotatably supporting the carrying means coupled to the vehicle. In embodiments, the interface component 108 (or interface component 116) provides a pictoral representation of the vehicle and/or the carrying means in which the payload is distributed. The pictoral representation provides a user with a visual representation of where the payload is with respect to the center of the vehicle and/or carrying means, or where the payload is with respect to the one or more axles.

With reference back to FIG. 2, it is determined 208 whether the weight of the payload is below a maximum weight threshold. Further, it is determined 210 whether the location of the payload is below a maximum distribution threshold with respect to one or more axles on the vehicle and or the carrying means. In embodiments, the load component 110 determines whether the weight of the payload is below a maximum weight threshold stored in the threshold data 112. The load component 110 further determines whether a location of the payload is below the maximum distribution threshold stored in the memory area with respect to the one or more axles. That is, the load component takes the information provided by the at least one sensor 114 and the information regarding maximum threshold values from the threshold data 112, and makes a determination as to whether the location of the payload is below the maximum distribution threshold stored in the memory area with respect to the one or more axles and a determination as to whether the payload exceeds a maximum weight threshold. As mentioned above, in one embodiment, the maximum distribution threshold is based off of what percentage of the payload is over a particular axle. For example, a maximum threshold occurs when 95% or more of the payload is over a desired axle. Further, the maximum weight threshold is 90% of the maximum weight requirement.

After all the information is gathered, the results are presented 212 to a user via interface component 108 or interface component 116. In embodiments, the interface components 108 and 116 provide a user with various warnings the closer an payload gets to a given threshold. For example, the interface components 108 and 116 provide a user with 1%-5% increments allowing a user to see a progression as a payload gets closer to the 90% maximum weight threshold or further away from the 95% maximum weight distribution threshold. These 1%-5% increments may be visual, audio or color coded. For example, as the payload reaches the respective thresholds, the audio warning gets louder and louder or a color becomes brighter and brighter.

### Exemplary Operating Environment

A computing device such as computing device 102 in FIG. 1 or a computer has one or more processors or processing units and a system memory. The computer typically has at least some form of computer readable media. Computer readable media, which include both volatile and nonvolatile media, removable and non-removable media, may be any available medium that may be accessed by computer. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. For example, computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information and that may be accessed by computer. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of any of the above are also included within the scope of computer readable media.

The system memory includes computer storage media in the form of removable and/or non-removable, volatile and/or nonvolatile memory. The computer may operate in a networked environment using logical connections to one or more remote computers, such as a remote computer.

Although described in connection with an exemplary computing system environment, embodiments of the invention are operational with numerous other general purpose or special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the exemplary operating environment. Examples of well known computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein. Aspects of the invention may also be practiced in distributed computing environments where tasks are performed by remote processing devices that are linked through a communications network. In a distributed computing environment, program modules may be located in both local and remote computer storage media including memory storage devices.

In operation, a computer executes computer-executable instructions embodied in one or more computer-executable components stored on one or more computer-readable media to implement aspects of the invention described and/or illustrated herein.

The embodiments illustrated and described herein as well as embodiments not specifically described herein but within the scope of aspects of the invention constitute exemplary means for means for defining the model, exemplary means for predicting the thermal strain, exemplary means for simultaneously solving equations for conservation of energy and conservation of mass based on the received data, exemplary means for calculating a radiant heat exchange rate among the fabric layers independent of the gap, and exemplary means for accounting for air exchange between the gap and ambient air external to the garments.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A method for measuring a weight and location of a payload in a carrying means coupled to a vehicle, the method comprising:
sensing the weight of the payload with at least one sensor;
sensing the location of the payload with the at least one sensor;
generating a location of the payload with respect to one or more axles rotatably supporting the carrying means;
determining whether the weight of the payload is below a maximum weight threshold, or determining whether the location of the payload is below a maximum distribution threshold with respect to the one or more axles; and
presenting results to a user.

2. The method according to claim 1, further comprising providing a pictoral representation of the carrying means coupled to the vehicle in which the payload is distributed.

3. The method according to claim 1, wherein the at least one sensor is on the floor of the carrying means.

4. The method according to claim 1, wherein the at least one sensor is embedded in the floor of the carrying means.

5. The method according to claim 1, wherein the at least one sensor is coupled to a suspension system of the carrying means.

6. The method according to claim 1, wherein a user is provided with a progressional warning as the payload becomes closer to the maximum distribution threshold and the maximum weight threshold.

7. The method according to claim 6, wherein the warning is one of the following, audio, pictoral, and color coded.

8. The method according to claim 1, wherein the maximum weight threshold is 90% of the maximum weight restriction of the carrying means coupled to the vehicle.

9. The method according to claim 1, wherein the maximum distribution threshold is 95% over a particular axle.

10. A system for measuring a weight and location of a payload in a carrying means coupled to a vehicle, the system comprising:
a memory area for storing weight and location thresholds including a maximum weight threshold and a maximum distribution threshold of the carrying means; and
a processor programmed to:
receive the weight of the payload determined by at lest one sensor;
receive the location of the payload determined by the at least one sensor;
generate a location of the payload with respect to one or more axles rotatably supporting the carrying means coupled to the vehicle;
determine whether the weight of the payload is below the maximum weight threshold stored in the memory area, or determine whether the location of the payload is below the maximum distribution threshold stored in the memory area with respect to the one or more axles; and
present results to a user.

11. The system according to claim 10, wherein the at least one sensor is on the floor of the carrying means.

12. The system according to claim 10, wherein the at least one sensor is embedded in the floor of the carrying means.

13. The system according to claim 10, wherein the at least one sensor is located on a suspension system of the carrying means.

14. The system according to claim 10, wherein the maximum weight threshold is 90% of the maximum weight restriction of the carrying means coupled to the vehicle.

15. The system according to claim 10, wherein the maximum distribution threshold is 95% over a particular axle.

16. A cargo transportation device comprising:
a cargo holding area;
a plurality of weight sensors dispersed about the cargo holding area; and
a load controller communicatively coupled to the weight sensors and programmed to ensure proper distribution with respect to a payload in the cargo holding area.

17. The cargo transportation device according to claim 16, a user interface communicatively coupled to the load controller, the user interface configured to provide a pictoral representation of the cargo holding area in which the payload is distributed.

18. The cargo transportation device according to claim 17, wherein the user interface is further configured to provide a user with a progressional warning as the payload becomes closer to a maximum distribution threshold and a maximum weight threshold.

19. The cargo transportation device according to claim 18, wherein the warning is one of the following, audio, pictoral, and color coded.

20. The cargo transportation device according to claim 16, wherein the cargo holding area is one of the following: a trailer, a railroad car, a boat, an airplane; a bed of a truck, an automobile, and an off road utility vehicle.
